(19) United States
(12) Patent Application Publication
(10) Pub. No.: US 2015/0180097 A1
(43) Pub. Date: Jun. 25, 2015

(54) Energy Storage Module and Method for Production of Energy Storage Module

(71) Applicant: Bayerische Motoren Werke Aktiengesellschaft, Muenchen (DE)

(72) Inventors: Robert LUSTIG, Muenchen (DE); Andreas SCHLEICHER, Muenchen (DE); Florian ENGEL, Muenchen (DE)

(21) Appl. No.: 14/640,130

(22) Filed: Mar. 6, 2015

Related U.S. Application Data
(63) Continuation of application No. PCT/EP2013/069193, filed on Sep. 17, 2013.

(30) Foreign Application Priority Data
Oct. 18, 2012 (DE) 10 2012 219 057.0

(51) Int. Cl. H01M 10/625; B32B 37/12; B32B 37/18; H01M 2/10; H01M 10/6567

(52) U.S. Cl. CPC H01M 10/5016; H01M 2/1077; H01M 10/5075; B32B 37/18; B32B 37/12; H01M 2220/20; B32B 2457/10

(57) ABSTRACT

An energy storage module, in particular for supplying electrical energy in a motor vehicle, includes a plurality of prismatic storage cells, each having a front side on which at least one power tap is arranged and having a back side opposing the front side, as well as longitudinal member having two opposing outer walls. The back side of at least one storage cell is positioned against each outer wall of the longitudinal member.

### CROSS REFERENCE TO RELATED APPLICATIONS

This application is a continuation of PCT International Application No. PCT/EP2013/069193, filed Sep. 17, 2013, which claims priority under 35 U.S.C. §119 from German Patent Application No. 10 2012 219 057.0, filed Oct. 18, 2012, the entire disclosures of which are herein expressly incorporated by reference.

### BACKGROUND AND SUMMARY OF THE INVENTION

The present invention relates to an energy storage module, in particular for supplying electric energy in a motor vehicle, to an energy storage arrangement having at least two said energy storage modules, to a motor vehicle in which the energy storage module or the energy storage arrangement is used, and to a method for producing the energy storage module.

The prior art includes various energy storage modules that are used in particular for supplying electric energy in a drive in the motor vehicle. These include vehicles that are driven exclusively electrically or with electrical support. A plurality of storage cells are combined in one energy storage module. Disposed in the individual storage cells is an electrochemical element that is embodied, for instance, as a lithium ion battery. A plurality of the energy storage modules may be combined in one motor vehicle to create a so-called energy storage arrangement.

It is the object of the present invention to provide an energy storage module that combines a plurality of storage cells in an operationally reliable and weight-optimized manner and with cost-effective production and assembly, wherein at the same time optimum cooling of the individual storage cells should be possible. It is furthermore the object of the invention to provide an energy storage arrangement in which a plurality of energy storage modules are combined. Moreover, a method for efficiently producing the energy storage modules should be provided.

This and other objects are achieve according to the invention by an energy storage module that includes a plurality of prismatic storage cells. Each storage cell includes a front side and a back side opposing the front side. At least one power tap is embodied on the front side. In particular, both power taps for the two poles are arranged on the front side. The prismatic storage cell is formed for instance by a pot-shaped housing, the so-called “can”, and a cover that seals the pot-shaped housing, the so-called cap. The cover in particular forms the front side of the storage cell. Moreover, the energy storage module includes a longitudinal member. The storage cells are positioned against both sides of the longitudinal member. This means that two storage cells are arranged opposing one another with respect to the longitudinal member. Two opposing outer walls are defined on the longitudinal member. The storage cells are arranged such that at least one storage cell is positioned against each outer wall. In particular, the storage cells lie flat in the motor vehicle so that the longitudinal member extends in the longitudinal or transverse direction of the motor vehicle. Because of the described arrangement of the storage cells along the two outer walls of the longitudinal member, the storage cells of an energy storage module lie parallel to one another and in one plane. The inventive use of the longitudinal member permits optimum cooling via the longitudinal member and permits a very flexible and modular structure, since as many storage cells as desired may be arranged on both sides along the longitudinal member. A plurality of the energy storage cells, each having a longitudinal member, may be arranged on top of and/or adjacent to one another in the motor vehicle.

It is preferably provided that a cooling device for cooling the opposing outer walls is arranged in the longitudinal member. The back sides of the storage cells and thus all of the storage cells are also cooled via the outer walls of the longitudinal member. In particular it is provided that the longitudinal member is hollow inside. For instance, the longitudinal member may be embodied as a hollow square profile. Two fluid-conducting channels are disposed in the interior of the longitudinal member, each channel being positioned against an outer wall. The two fluid-conducting channels convey a coolant fluid. The two cooling channels may also be connected to one another. An expansion device is, in particular, provided between the two cooling channels in order to provide secure positioning of the cooling channels against the interior surfaces of the outer walls. This expansion device presses the two cooling channels outward and thus against the outer walls. The expansion device is formed in particular by one or a plurality of expansion anchors or expansion sleeves. Each cooling channel is in particular formed as a flat tube that is positioned against the interior of the outer wall. As an alternative to the flat tube, it is also possible for a plurality of small tubes to be arranged above one another.

Furthermore, it is preferably provided that the storage cells are fixed via transverse members. The transverse members are securely connected to the longitudinal members. The transverse members are, in particular, perpendicular to the longitudinal member. It is preferably provided that one transverse member fixes at least two opposing storage cells. The transverse member thus extends in both directions perpendicular to the longitudinal member and therefore extends across the two opposing storage cells. In particular upper and lower transverse members are arranged so that the storage cells are clamped between two transverse members.

A damping element may preferably be arranged between a transverse member and a storage cell. This damping element is, for instance, a mat made of elastic material.

It is particularly preferably provided that the transverse members are relatively narrow and do not cover the entire surface area of the storage cells. This ensures a structure that is optimized in terms of weight. To this end it is defined that a width of the transverse member and a width of the storage cells are measured in the direction parallel to the longitudinal member. The width of the transverse member is at most 80%, preferably at most 50%, of the width of the storage cells.

The storage cells are, in particular, embodied as rectangles. The rectangular shape of the storage cells has one largest surface area. This surface area is advantageously perpendicular to the front side and to the back side. The front and back sides are thus relatively small sides of the rectangular shape. The advantageous aforesaid transverse member presses against the largest surface area of this rectangular shape.

The invention furthermore includes an energy storage arrangement. At least two of the aforesaid energy storage modules are combined in the energy storage arrangement. Advantageously, one transverse member is connected to the longitudinal members of two energy storage modules. Thus in the energy storage arrangement, not only does the transverse member fix the individual storage cells, it also connects the individual energy storage modules to one another.

Moreover, the invention includes a motor vehicle having at least one of the energy storage modules or one of the energy storage arrangements. The energy storage modules or energy storage arrangements are arranged in the motor vehicle such that the storage cells are positioned. This means that the largest surface area of the prismatic storage cells are arranged horizontally in the motor vehicle. Because of this a very space-saving structure is possible in the motor vehicle.

The advantageous embodiments described in the context of the inventive energy storage module may also be advantageously applied to the inventive energy storage arrangement and to the inventive motor vehicle.

Moreover, the invention includes a method for producing an energy storage module. In the method, first a plurality of prismatic storage cells are prepared. Then the storage cells are glued onto a planar film. The back sides of the storage cells are glued to the film. Those storage cells that at the end of the method are disposed opposing the longitudinal member are glued to the film spaced apart from one another. The film provides electrical insulation between longitudinal member and storage cells. Once the storage cells have been glued on, the film with the storage cells glued thereto is placed about the longitudinal member so that one of the storage cells is positioned against each outer wall of the longitudinal member.

Alternatively, it is also possible to use the following method for producing an energy storage module: first at least two prismatic storage cells having a front side on which at least one power tap is arranged, and having a back side opposing the front side, and a longitudinal member having two opposing outer walls, are prepared. Then at least one first storage cell is glued onto a first film and at least one second storage cell is glued onto a second film, the back sides of the storage cells being glued. Then the first film having the first storage cells glued thereto is placed on, especially glued to, a first outer wall of the longitudinal member and the second film having the second storage cells glued thereto is placed on, especially glued to, a second outer wall of the longitudinal member.

Further alternatively, the following method for producing an energy storage module may also be used: first at least two prismatic storage cells having a front side on which at least one power tap is arranged, and having a back side opposing the front side, and one longitudinal member having two opposing outer walls, are prepared. Then a first film is glued to a first outer wall and a second film is glued to a second outer wall of the longitudinal member. Then at least one first storage cell is glued to the first film and at least one second storage cell is glued to the second film, the back sides of the storage cells being glued.

The power taps may advantageously be contacted to the storage cells even prior to the film being placed about the longitudinal member. During contacting, that is for instance while the conduction rails or wiring is being attached to the power taps, the back sides of the storage cells are on the film and thus may be processed from above.

The film with the storage cells glued on facilitates positioning and attaching the storage cells to the longitudinal member.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a perspective view depicting an inventive energy storage module in accordance with a first exemplary embodiment;

FIG. 2 is a perspective view depicting a longitudinal member of the inventive energy storage module in accordance with the first exemplary embodiment;

FIG. 3 depicts a method step for producing the energy storage module in accordance with the first exemplary embodiment;

FIG. 4 depicts part of a transverse member of the inventive energy storage module in accordance with a first exemplary embodiment; and,

FIGS. 5-8 depict a plurality of method steps (S1-S11) for producing an energy storage arrangement in accordance with a second exemplary embodiment.

### DETAILED DESCRIPTION OF THE DRAWINGS

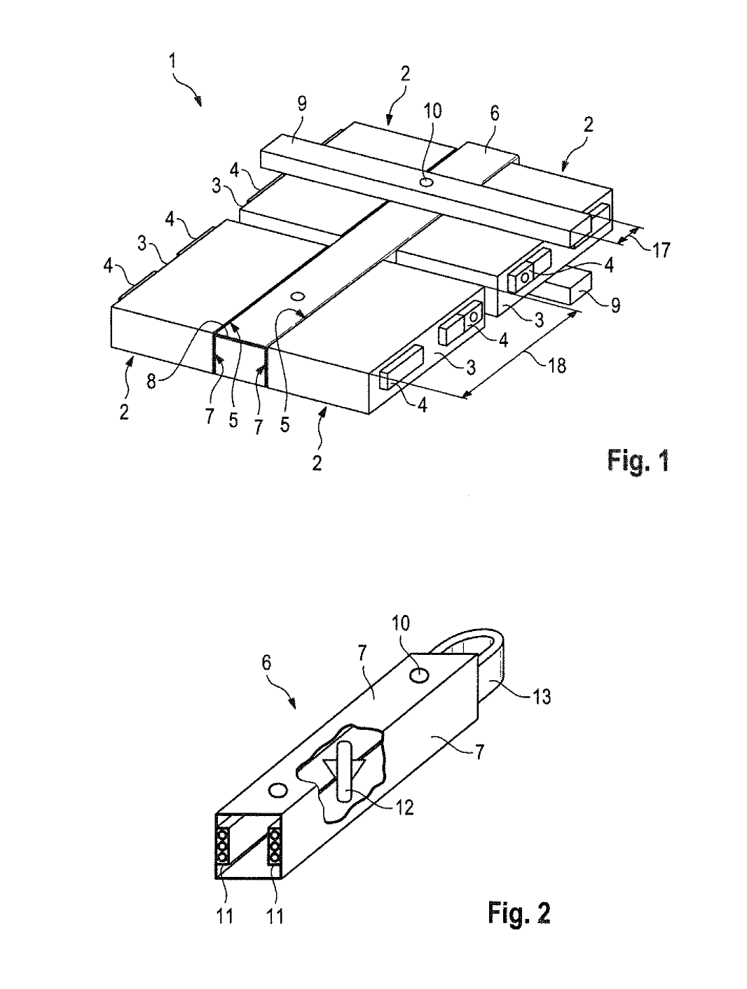

An energy storage module 1 is described in detail in the following using FIGS. 1 through 4.

The energy storage module 1 includes a plurality of storage cells 2. FIG. 1 depicts four storage cells 2. Each storage cell has a basic rectangular shape. Two power taps 4 are embodied on the front side 3 of each storage cell 2. A back side 5 of the storage cell 2 is opposite each front side 3.

The energy storage module 1 furthermore includes a longitudinal member 6. The longitudinal member 6 is embodied as an interiorly hollow square profile. Two opposing outer walls 7 are defined on the longitudinal member 6. In the exemplary embodiment depicted, two storage cells 2 are positioned against each outer wall 7. The back side 5 of each storage cell 2 is positioned against the outer wall 7.

A film 8 is arranged about the longitudinal member 6 for electric insulation between longitudinal member 6 and storage cells 2.

Moreover, FIG. 1 depicts two transverse members 9. The transverse members 9 are arranged perpendicular to the longitudinal member 6 and are securely connected to the longitudinal member 6 via a connector 10. The connector 10 is, for instance, a weld, screw, or rivet connector. Two opposing storage cells 2 are clamped between two opposing transverse members 9. The transverse members 9 may thus counter the internal pressure that occurs in the interior of the storage cell 2.

For the purposes of simplifying the depiction, in FIG. 1 only the two rear transverse members 9 are shown. Naturally, the two front storage cells 2 are also fixed with two transverse members 9.

FIG. 1 further depicts a transverse member width 17 and a storage cell width 18. As may be seen, the transverse member width 17 is significantly smaller than the storage cell width 18. Because of this it is possible to construct the energy storage module 1 such that its weight is optimized.

FIG. 2 provides a schematic view of the longitudinal member 6. Two opposing cooling channels 11 are arranged in the longitudinal member 6. Each cooling channel 11 is formed by a plurality of small tubes positioned above one another so that the cooling channel 11 is positioned very well against the outer wall 7. A breakaway in the longitudinal member 6 reveals an expansion device 12 arranged in the longitudinal member. This expansion device 12 presses the two cooling channels 11 away from one another and thus against the outer walls 7. The two cooling channels 11 are connected to one another via a direction change element 13. The depiction selected in FIG. 2 shall not be limiting. It is also possible to embody the cooling channel 11 as a single flat tube, a so-called flat tube.

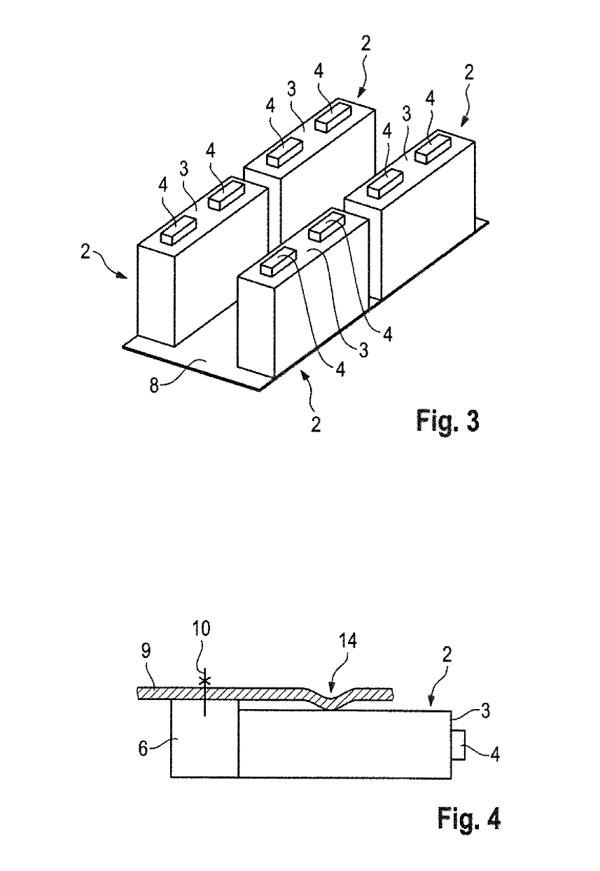

FIG. 3 depicts one possible production step for the energy storage module 1. Before the storage cells 2 are positioned against the longitudinal member 6, the back side 5 of the storage cells 2 is glued to the film 8. The storage cells 2 stand horizontally and the power taps 4 are easily accessible and may even be contacted in this method step. After the storage cells 2 have been glued to the film 8, the film 8 is placed about the longitudinal member such that the arrangement in accordance with FIG. 1 is created.

FIG. 4 is a schematic representation of the detailed embodiment of the transverse member 9. In accordance with FIG. 4, a pressing segment 14 is embodied on the transverse member 9. The transverse member 9 at this pressing segment 14 extends somewhat in the direction of the storage cells 2 so that it is possible to fix and attach the storage cells 2 with no clearance by way of the transverse member 9.

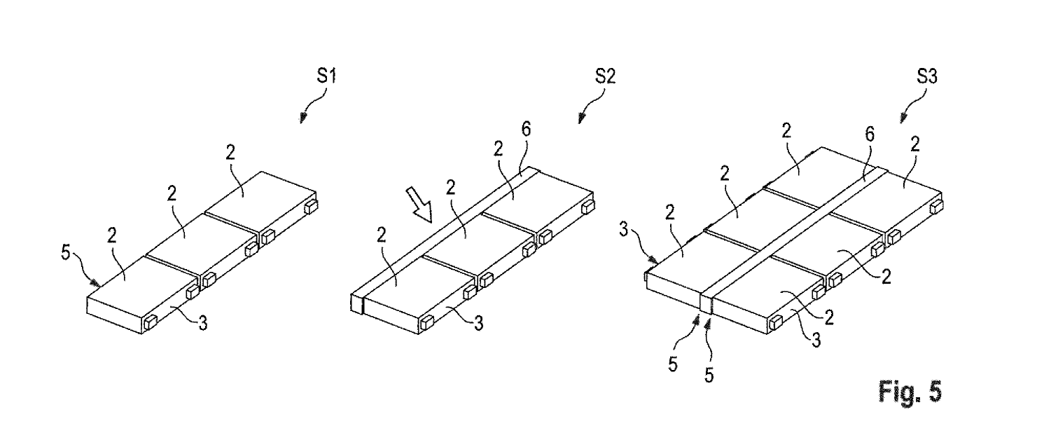

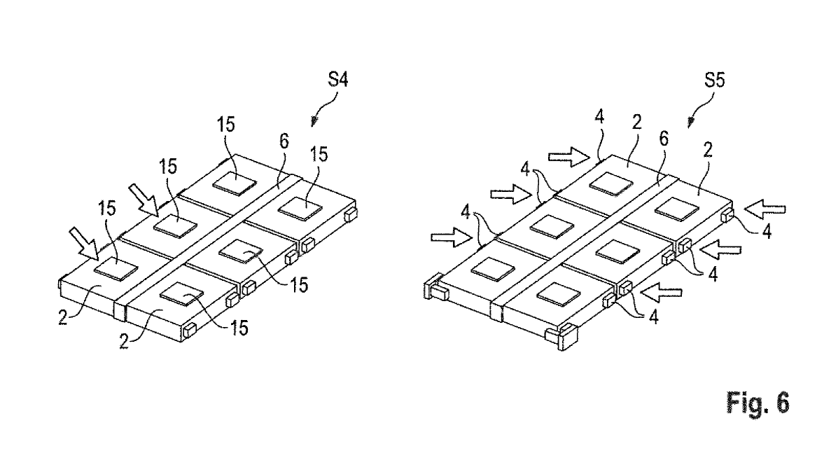

FIGS. 5 through 8 depict method steps S1 through S11 for producing an energy storage module 1 and for assembling a plurality of energy storage modules 1 to create one energy storage arrangement 16. In accordance with method steps S1 through S3, the back sides 5 of the storage cells 2 are arranged on both sides of the longitudinal member against its outer walls 7. FIG. 5 depicts an alternative assembly to FIG. 3. The further method steps in FIGS. 6 through 8 may be accomplished regardless of whether assembly is in accordance with FIG. 5 or FIG. 3.

In the alternative assembly depicted in FIG. 5, storage cells 2 are attached to the longitudinal member 6 in two successive steps, first to a first outer wall and then to a second outer wall. For insulation reasons, in this alternative assembly, as well, a film 8 (not shown in FIG. 5) should be provided for electrical insulation between longitudinal member 6 and storage cells 2; however, in this case placing the film 8 about the longitudinal member 6 is not required because the storage cells 2 are attached to the longitudinal member 6 in two steps. Instead, a discrete, electrically insulating film is attached to both outer walls 7 of the longitudinal member 6 and the storage cells 2 are then glued to the film. Alternatively, it may be provided that the storage cells 2 provided for the first outer wall and the storage cells 2 provide for the second outer wall are first glued to discrete films, and the storage cells 2 glued to the films are then attached, especially glued, to the specific outer wall. In another alternative it may be provided that storage cells 2 are used that already have an electrically insulating film attached to their back side 5. In this case, storage cells may be attached individually to the longitudinal member 6.

FIG. 6 illustrates that a damping element 15 is applied to each storage cell 2. This damping element 15 is, for instance, a rubber mat. The pressing segment 14 for the transverse member 9 presses against the storage cell 2 via this damping element 15. The power taps 4 of the individual storage cells 2 are contacted in step S5.

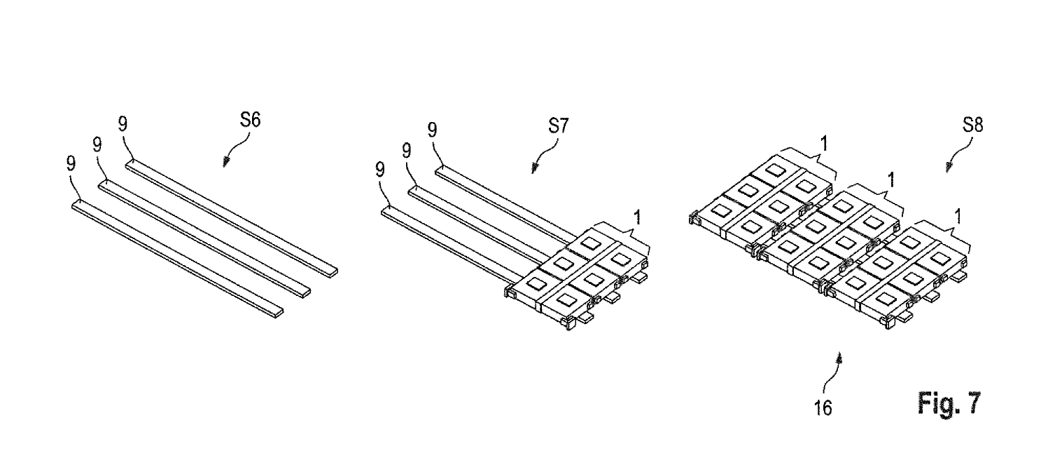

Method steps S6 through S8 in FIG. 7 illustrate that a plurality of energy storage modules 1 may be combined to create one energy storage arrangement 16. Three of the energy storage modules 1 are shown in step S8. In the depicted exemplary embodiment, the transverse members 9 are used not only for fixing the storage cells 2, but also for connecting the longitudinal member 6 of the individual storage modules 1 to one another.

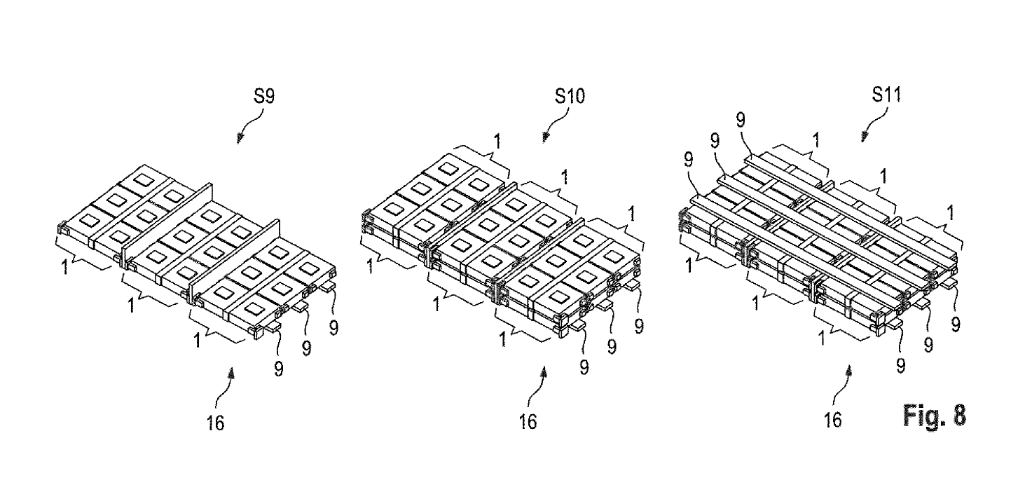

Three of the energy storage modules 1 are arrayed adjacent to one another in FIG. 7. FIG. 8 illustrates that the energy storage modules 1 may also be stacked on one another. In step S9, three energy storage modules 1 are disposed adjacent to one another. In step S10, three energy storage modules are again positioned and in step S11 three transverse members 9 are placed on top. As step S11 illustrates, transverse members 9 are not required in each plane. Thus, for instance, a plurality of storage cells 2 arranged on top of one another may be fixed by two opposing transverse members 9.

### REFERENCE LIST

1 Energy storage module

2 Storage cells

3 Front side

4 Power tap

5 Back side

6 Longitudinal member

7 Outer walls

8 Film

9 Transverse member

10 Connector

11 Cooling channels

12 Expansion device

13 Direction change element

14 Pressing segment

15 Damping element

16 Energy storage arrangement

17 Transverse member width

18 Storage cell width

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. An energy storage module for supplying electrical energy in a motor vehicle, comprising:
a plurality of prismatic storage cells, each having a front side on which at least one power tap is arranged and having a back side opposing the front side; and
a longitudinal member having two opposing outer walls, the back side of at least one storage cell being positioned against one of the two opposing outer walls and the back side of at least one other storage cell being position against the other of the two opposing outer walls.

2. The energy storage module according to claim 1, further comprising:
a cooler for cooling the opposing outer walls, the cooler being arranged in the longitudinal member.

3. The energy storage module according to claim 2, wherein the cooler comprises fluid-conducting cooling channels arranged in the interior of the longitudinal member against each of the two outer walls.

4. The energy storage module according to claim 3, further comprising:
an expansion device between the two cooling channels, the expansion device being configured to press the cooling channels against the outer walls.

5. The energy storage module according to claim 4, further comprising:
at least one transverse member that is securely connected to the longitudinal member, one transverse member fixing two opposing storage cells.

6. The energy storage module according to claim 1, further comprising:
at least one transverse member that is securely connected to the longitudinal member, one transverse member fixing two opposing storage cells.

7. The energy storage module according to claim 5, further comprising:
a damping element arranged between the transverse member and the storage cell.

8. The energy storage module according to claim 7, wherein the damping element is an elastic mat.

9. The energy storage module according to claim 6, further comprising:
a damping element arranged between the transverse member and the storage cell.

10. The energy storage module according to claim 6, wherein a width of the transverse member and a width of the storage cell are defined parallel to the longitudinal member, the width of the transverse member being at most 80% of the width of the storage cell.

11. The energy storage module according to claim 6, wherein a width of the transverse member and a width of the storage cell are defined parallel to the longitudinal member, the width of the transverse member being at most 50% of the width of the storage cell.

12. The energy storage module according to claim 9, wherein a width of the transverse member and a width of the storage cell are defined parallel to the longitudinal member, the width of the transverse member being at most 50% of the width of the storage cell.

13. The energy storage module according to claim 1, wherein the storage cells are rectangular shaped, a largest surface area of the rectangular shape being perpendicular to the front side and back side.

14. The energy storage module according to claim 2, wherein the energy storage module is arrange in a motor vehicle such that a largest surface area of the plurality of prismatic storage cells is oriented horizontally in the motor vehicle.

15. An energy storage arrangement, comprising:
at least two energy storage modules, each energy storage module comprising a plurality of prismatic storage cells, each having a front side on which at least one power tap is arranged and having a back side opposing the front side; and a longitudinal member having two opposing outer walls, the back side of at least one storage cell being positioned against one of the two opposing outer walls and the back side of at least one other storage cell being position against the other of the two opposing outer walls; and
at least one transverse member, the transverse member being securely connected to the longitudinal members of the at least two energy storage modules.

16. A method for producing an energy storage module, the method comprising the acts of:
providing at least two prismatic storage cells having a front side on which at least one power tap is arranged and having a back side that opposes the front side,
gluing the at least two storage cells to a common film, the back side of the storage cells being glued,
providing a longitudinal member having two opposing outer walls, and
placing the film with the storage cells glued thereto about the longitudinal member so that the back side of at least one storage cell is positioned against each outer wall.

17. A method for producing an energy storage module, the method comprising the acts of:
providing at least two prismatic storage cells having a front side on which at least one power tap is arranged and having a back side that opposes the front side,
providing a longitudinal member having two opposing outer walls;
gluing at least one first storage cell to a first film and at least one second storage cell to a second film, the back side of the storage cells being glued; and
placing the first film with the first storage cells glued thereto against a first outer wall of the longitudinal member and the second film with the second storage cells glued thereto against a second outer wall of the longitudinal member.

18. A method for producing an energy storage module, the method comprising the acts of:
providing at least two prismatic storage cells having a front side on which at least one power tap is arranged and having a back side that opposes the front side;
providing a longitudinal member having two opposing outer walls;
gluing a first film onto a first outer wall and a second film onto a second outer wall of the longitudinal member; and
gluing at least a first storage cell onto the first film and at least a second storage cell onto the second film, the back side of the storage cells being glued.
